(19) United States
(12) Patent Application Publication
(10) Pub. No.: US 2013/0314788 A1
(43) Pub. Date: Nov. 28, 2013

(54) REFLECTIVE OPTICAL FILM AND METHOD OF MANUFACTURING THE SAME, AND IMAGE DISPLAY DEVICE

(71) Applicants: JEN-HUAI CHANG, TAOYUAN COUNTY (TW); CHAO-YING LIN, NEW TAIPEI CITY (TW)

(72) Inventors: JEN-HUAI CHANG, TAOYUAN COUNTY (TW); CHAO-YING LIN, NEW TAIPEI CITY (TW)

(73) Assignee: EXTEND OPTRONICS CORP., TAOYUAN COUNTY (TW)

(21) Appl. No.: 13/479,346

(22) Filed: May 24, 2012

(51) Int. Cl. G02B 5/30; B29D 11/00

(52) U.S. Cl. 359/489.01; 264/1.9

(57) ABSTRACT

A reflective optical film includes a reflective light-polarizing unit including a multilayer reflective sheet composed of a plurality of polymer films stacked on top of one another. Each polymer film has a thickness, every two adjacent polymer films are two different materials, and the thicknesses of the polymer films are gradually decreased from two outmost sides of the multilayer reflective sheet to a middle of the multilayer reflective sheet. At least one of the polymer films is a birefringence material layer that conforms to the condition of NX≠NY≠NZ, where NX is the index of refraction of light at X direction of the multilayer reflective sheet, NY is the index of refraction of light at Y direction of the multilayer reflective sheet, and NZ is the index of refraction of light at Z direction of the multilayer reflective sheet.

### BACKGROUND OF THE INVENTION

1. Field of the Invention

The instant disclosure relates to a reflective optical film and a method of manufacturing the same, and an image display device, and more particularly, to a reflective optical film having a thickness gradient variation and a method of manufacturing the same, and an image display device using a reflective optical film having a thickness gradient variation.

2. Description of Related Art

Polymeric optical films are used in a wide variety of applications such as reflective polarizers. Such reflective polarizer films are used, for example, in conjunction with backlights in liquid crystal displays. A reflective polarizing film can be placed between the user and the backlight to recycle polarized light that would be otherwise absorbed, and thereby increasing brightness. These polymeric optical films often have high reflectivity, while being lightweight and resistant to breakage. Thus, the films are suited for use as reflectors and polarizers in compact electronic displays, such as liquid crystal displays (LCDs) placed in mobile telephones, personal data assistants, portable computers, desktop monitors, and televisions, for example. In commercial processes, optical films made from polymeric materials or blends of materials are typically extruded from a die using a feedblock or cast from solvent. The extruded or cast film is then stretched to create and/or enhance birefringence in at least some of the materials. The materials and the stretching protocol may be selected to produce an optical film such as a reflective optical film, for example, a reflective polarizer or a mirror.

### SUMMARY OF THE INVENTION

One aspect of the instant disclosure relates to a reflective optical film having a thickness gradient variation.

Another one aspect of the instant disclosure relates to a method of manufacturing a reflective optical film having a thickness gradient variation.

Yet another one aspect of the instant disclosure relates to an image display device using a reflective optical film having a thickness gradient variation.

One of the embodiments of the instant disclosure provides a reflective optical film, comprising: a reflective light-polarizing unit including a multilayer reflective sheet composed of a plurality of polymer films stacked on top of one another, wherein each polymer film has a thickness, every two adjacent polymer films are two different materials, the thicknesses of the polymer films are gradually decreased from two outmost sides of the multilayer reflective sheet to a middle of the multilayer reflective sheet, at least one of the polymer films is a birefringence material layer that conforms to the condition of NX≠NY≠NZ, wherein NX is the index of refraction of light at X direction of the multilayer reflective sheet, NY is the index of refraction of light at Y direction of the multilayer reflective sheet, and NZ is the index of refraction of light at Z direction of the multilayer reflective sheet.

Another one of the embodiments of the instant disclosure provides a method of manufacturing a reflective optical film, comprising: forming a multilayer reflective sheet composed of a plurality of polymer films stacked on top of one another by a co-extrusion process, wherein each polymer film has a thickness, every two adjacent polymer films are two different materials, the thicknesses of the polymer films are gradually decreased from two outmost sides of the multilayer reflective sheet to a middle of the multilayer reflective sheet, at least one of the polymer films is a birefringence material layer that conforms to the condition of NX≠NY≠NZ, wherein NX is the index of refraction of light at X direction of the multilayer reflective sheet, NY is the index of refraction of light at Y direction of the multilayer reflective sheet, and NZ is the index of refraction of light at Z direction of the multilayer reflective sheet; and extending the multilayer reflective sheet.

Yet another one of the embodiments of the instant disclosure provides an image display device, comprising: a reflective light-polarizing unit and an image display unit. The reflective light-polarizing unit includes a multilayer reflective sheet composed of a plurality of polymer films stacked on top of one another, wherein each polymer film has a thickness, every two adjacent polymer films are two different materials, the thicknesses of the polymer films are gradually decreased from two outmost sides of the multilayer reflective sheet to a middle of the multilayer reflective sheet, at least one of the polymer films is a birefringence material layer that conforms to the condition of NX≠NY≠NZ, wherein NX is the index of refraction of light at X direction of the multilayer reflective sheet, NY is the index of refraction of light at Y direction of the multilayer reflective sheet, and NZ is the index of refraction of light at Z direction of the multilayer reflective sheet. The image display unit includes at least one image display screen, wherein the reflective light-polarizing unit is disposed on one of the top side and the bottom side of the at least one image display screen or between the at least one image display screen and a backlight module.

In conclusion, because the thicknesses of the polymer films are gradually decreased from the two outmost sides of the multilayer reflective sheet to the middle of the multilayer reflective sheet, the shearing force can be reduced and the fluid velocity and the fluid pressure in the flow channel can be balanced during the co-extrusion process of manufacturing the multilayer reflective sheet.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a lateral, schematic view of the multilayer reflective sheet according to the instant disclosure;

FIG. 1B shows a lateral, schematic view of the reflective optical film according to the first embodiment of the instant disclosure;

FIG. 1C shows a curve schematic diagram of different layers of the multilayer reflective sheet corresponding to different thicknesses (such as μm);

FIG. 1D shows a curve schematic diagram of different wavelengths corresponding to different reflectivity when using 50 layers of the multilayer reflective sheet having a thickness gradient variation according to the instant disclosure;

FIG. 1E shows a curve schematic diagram of different wavelengths corresponding to different reflectivity when using 50 layers of the multilayer reflective sheet having a thickness increasing variation according to the prior art;

FIG. 1F shows a curve schematic diagram of different wavelengths corresponding to different reflectivity when using 200 layers of the multilayer reflective sheet having a thickness gradient variation according to the instant disclosure;

FIG. 1G shows a curve schematic diagram of different wavelengths corresponding to different reflectivity when using 200 layers of the multilayer reflective sheet having a thickness increasing variation according to the prior art;

FIG. 1H shows a curve schematic diagram of different wavelengths corresponding to different reflectivity when using 500 layers of the multilayer reflective sheet having a thickness gradient variation according to the instant disclosure;

FIG. 1I shows a curve schematic diagram of different wavelengths corresponding to different reflectivity when using 500 layers of the multilayer reflective sheet having a thickness increasing variation according to the prior art;

FIG. 1J shows a flowchart of the method of manufacturing the reflective optical film according to the first embodiment of the instant disclosure;

FIG. 1K shows an instrument schematic diagram for manufacturing the reflective optical film by a co-extrusion process according to the instant disclosure;

FIG. 1L shows a lateral, schematic view of the reflective light-polarizing unit applied to the image display unit according to the first embodiment of the instant disclosure;

FIG. 1M shows a schematic diagram of the semicircle feedblock according to the instant disclosure;

FIG. 2A shows a lateral, schematic view of the reflective optical film according to the second embodiment of the instant disclosure;

FIG. 2B shows a flowchart of the method of manufacturing the reflective optical film according to the second embodiment of the instant disclosure;

FIG. 3A shows a lateral, schematic view of the reflective optical film according to the third embodiment of the instant disclosure;

FIG. 3B shows a flowchart of the method of manufacturing the reflective optical film according to the third embodiment of the instant disclosure;

FIG. 4A shows a lateral, schematic view of the reflective optical film according to the fourth embodiment of the instant disclosure;

FIG. 4B shows a flowchart of the method of manufacturing the reflective optical film according to the fourth embodiment of the instant disclosure;

FIG. 5A shows a lateral, schematic view of the reflective optical film according to the fifth embodiment of the instant disclosure;

FIG. 5B shows a flowchart of the method of manufacturing the reflective optical film according to the fifth embodiment of the instant disclosure;

FIG. 6A shows a lateral, schematic view of the reflective optical film according to the sixth embodiment of the instant disclosure;

FIG. 6B shows a flowchart of the method of manufacturing the reflective optical film according to the sixth embodiment of the instant disclosure;

FIG. 7 shows a lateral, schematic view of the reflective light-polarizing unit applied to the image display unit according to the seventh embodiment of the instant disclosure;

FIG. 8 shows a lateral, schematic view of the reflective light-polarizing unit applied to the image display unit according to the eighth embodiment of the instant disclosure; and

FIG. 9 shows a lateral, schematic view of the reflective light-polarizing unit applied to the image display unit according to the ninth embodiment of the instant disclosure.

### DETAILED DESCRIPTION OF THE PREFERRED EMBODIMENTS

### First Embodiment

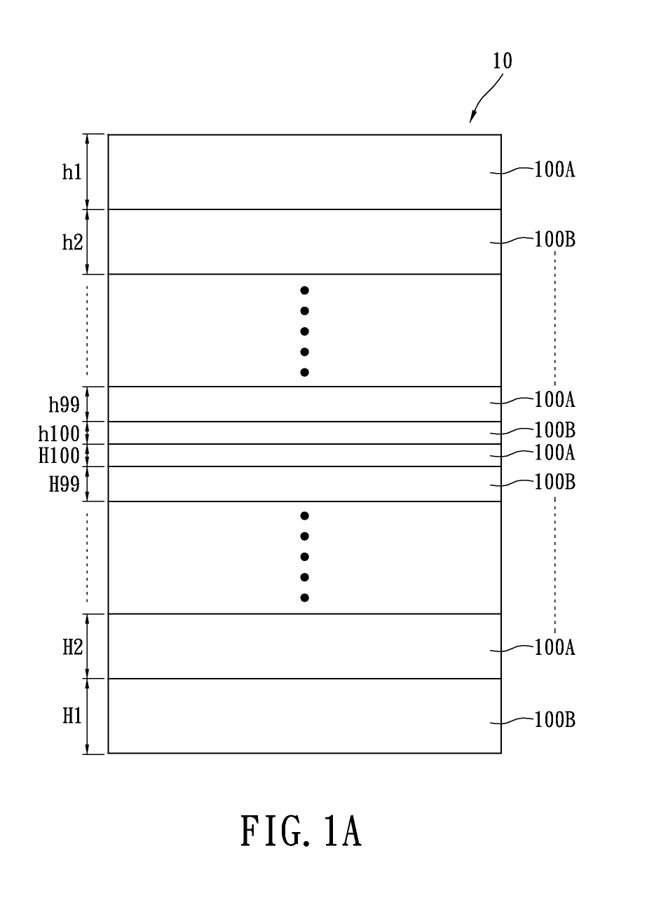

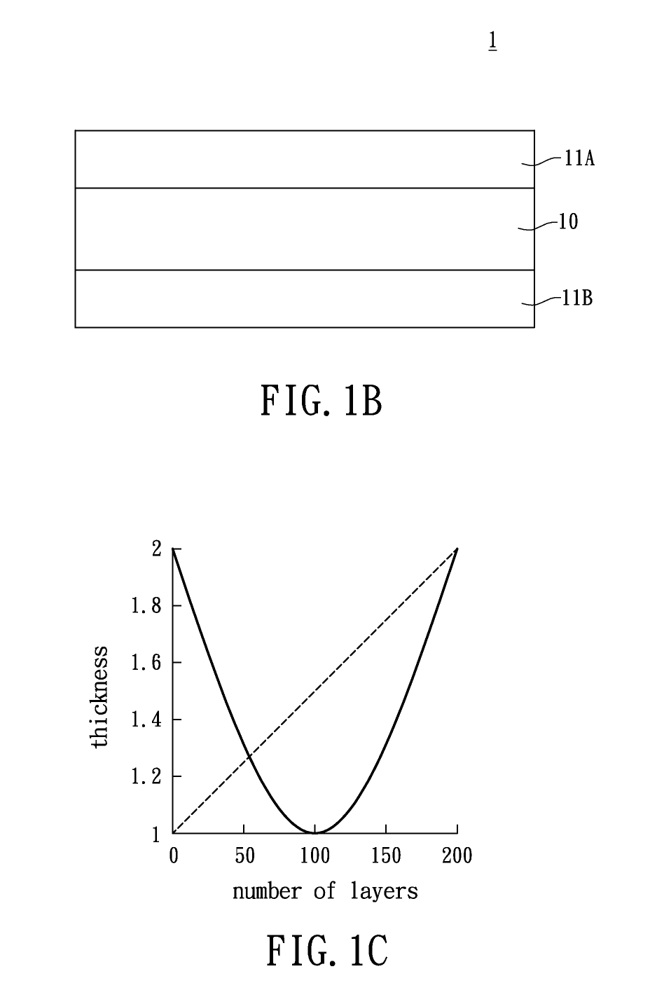

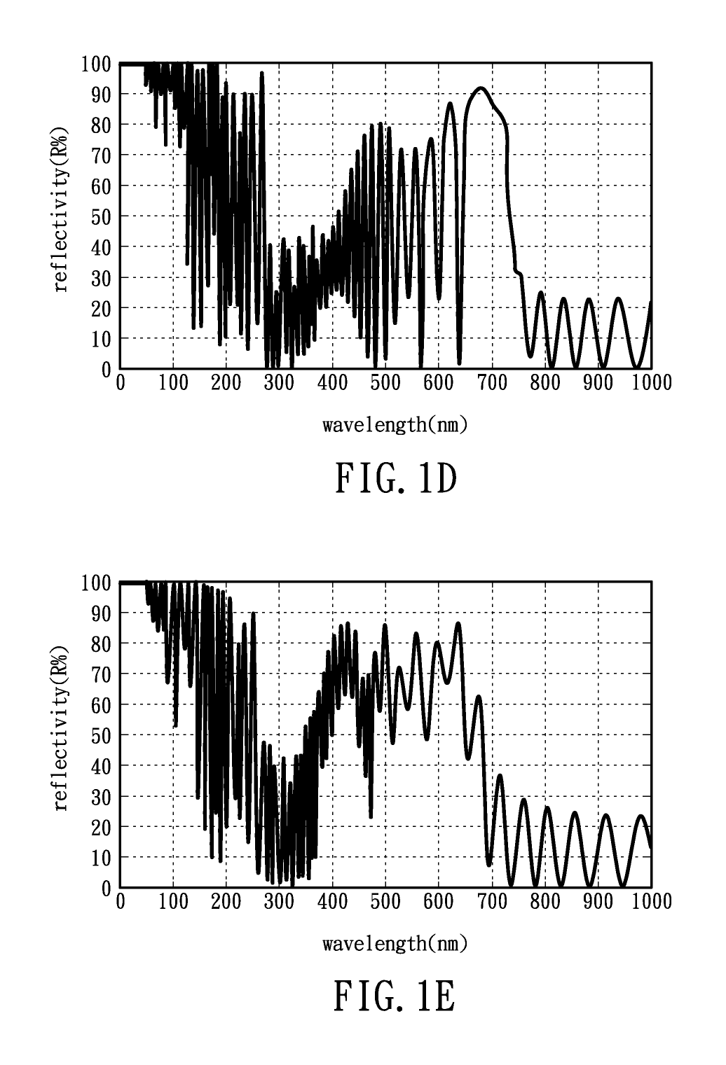

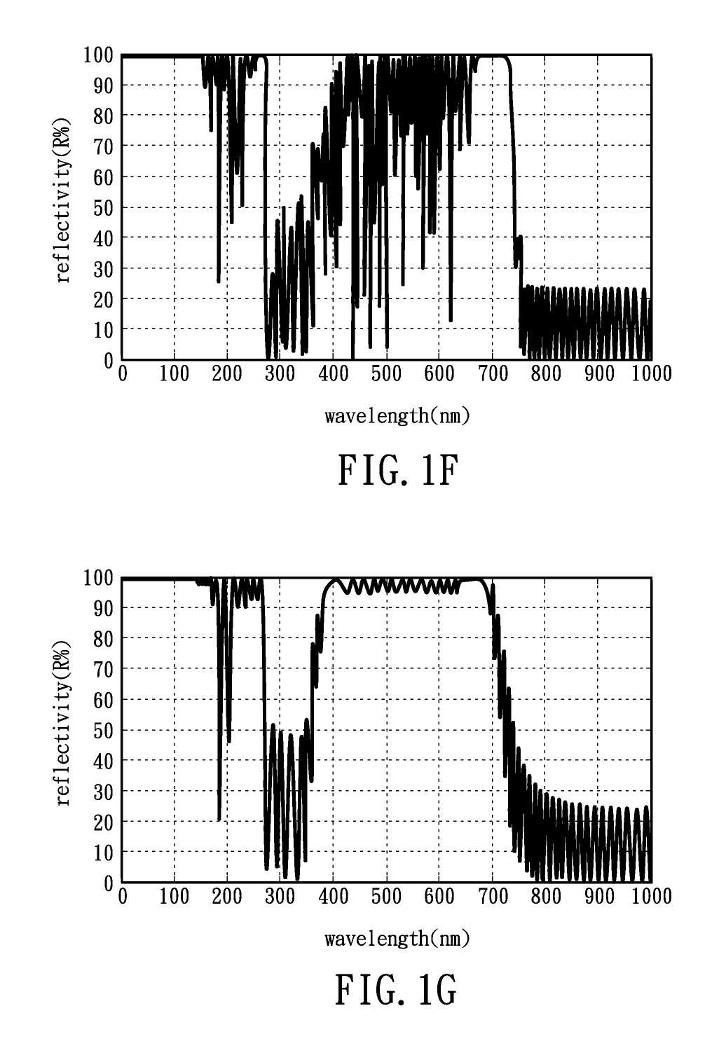

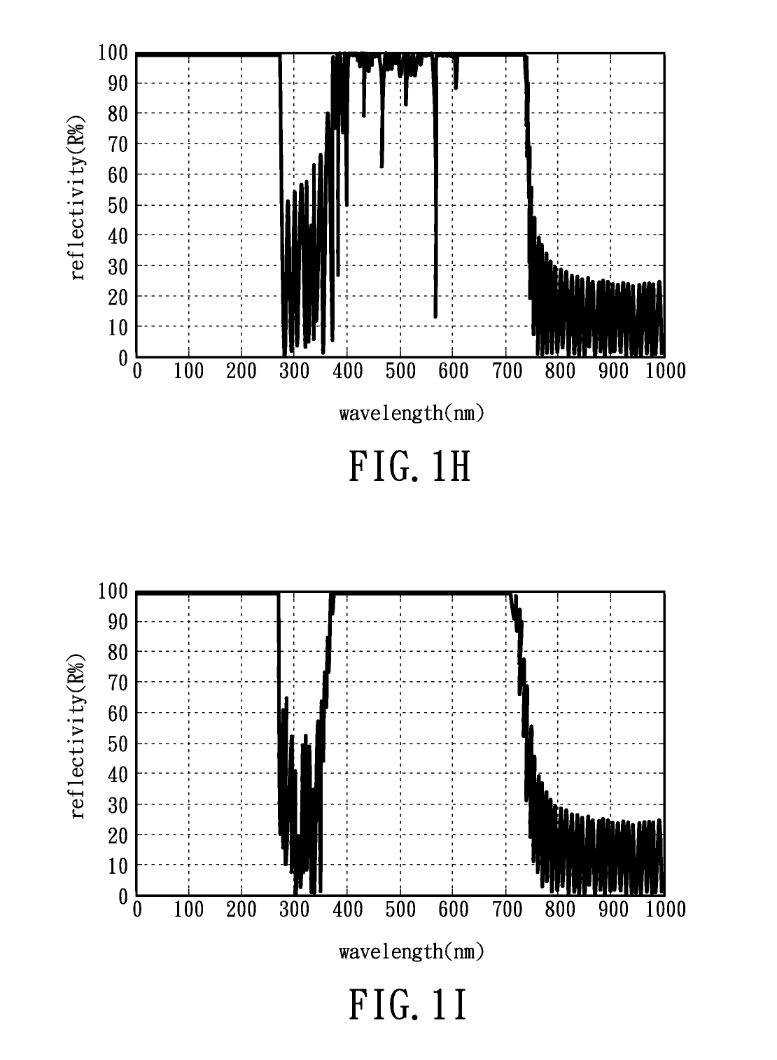

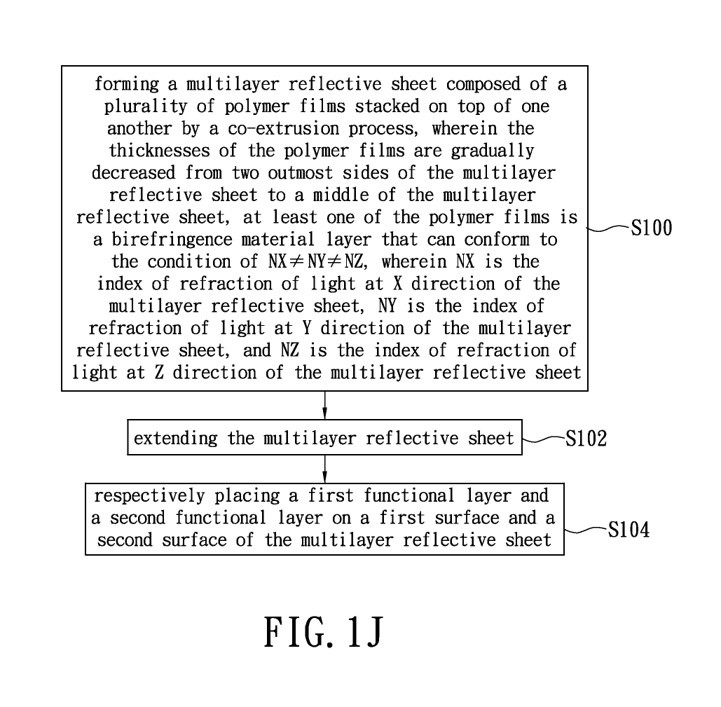

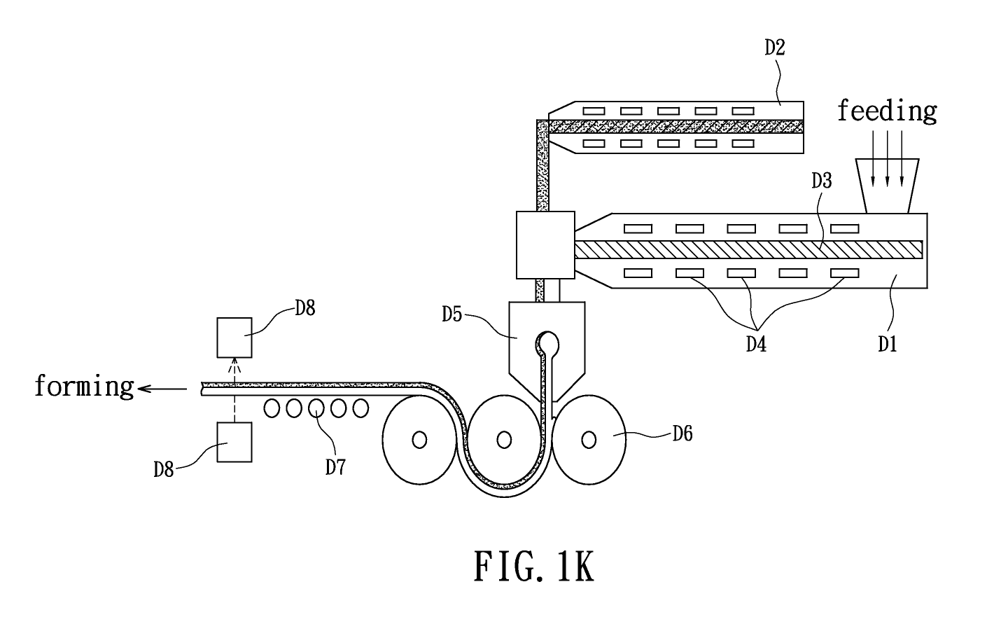

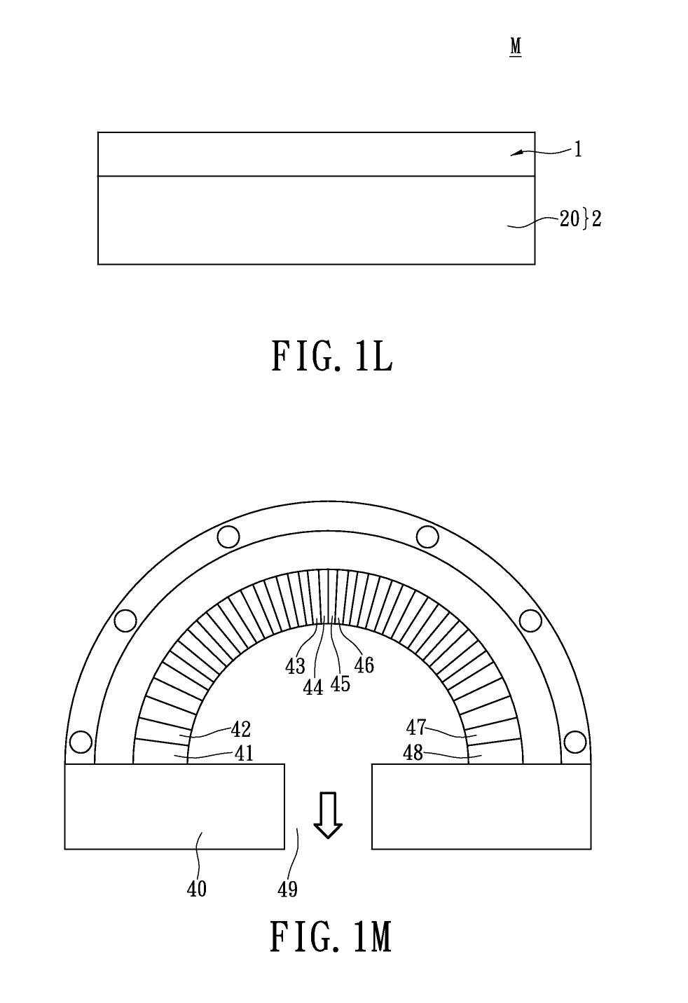

Referring to FIG. 1A to FIG. 1C, the first embodiment of the instant disclosure provides a reflective optical film comprising a reflective light-polarizing unit 1 that includes a multilayer reflective sheet 10 composed of a plurality of polymer films (100A, 100B) stacked on top of one another, a first functional layer 11A and a second functional layer 11B. Each polymer film (100A or 100B) has a thickness, every two adjacent polymer films (100A, 100B) are two different materials or made of two different materials, and the thicknesses of the polymer films (100A, 100B) are gradually decreased from two outmost sides of the multilayer reflective sheet 10 to a middle of the multilayer reflective sheet 10 (as shown in FIG. 1A). The multilayer reflective sheet 10 can be manufactured to form a symmetrical thickness structure by mating feedblocks and multipliers, thus the fluid velocity and the fluid pressure in the flow channels of the feedblock can be balance due to the symmetrical thickness structure. Of course, the thicknesses of the polymer films (100A, 100B) also can be gradually increased from two the outmost sides of the multilayer reflective sheet 10 to the middle of the multilayer reflective sheet 10, thus the fluid pressure and the fluid velocity in the flow channel of the feedblock also can be balanced. In addition, at least one of the polymer films (100A, 100B) is a birefringence material layer that can conform to the condition of NX≠NY≠NZ, wherein NX is the index of refraction of light at X direction of the multilayer reflective sheet 10, NY is the index of refraction of light at Y direction of the multilayer reflective sheet 10, and NZ is the index of refraction of light at Z direction of the multilayer reflective sheet 10. Moreover, referring to FIG. 1B, the first functional layer 11A and the second functional layer 11B are respectively disposed on a first surface and a second surface of the multilayer reflective sheet 10. For example, the first functional layer 11A and the second functional layer 11B may be a metal oxide layer or an ultraviolet absorbing layer.

For example, referring to FIG. 1A, the multilayer reflective sheet 10 can be composed of 200 polymer films (100A, 100B) stacked on top of one another, and the polymer films (100A, 100B) have different thicknesses (H1, H2, . . . , H99, H100; h1, h2, . . . , h99, and h100). Hence, the thicknesses (H1˜H100) of 100 polymer films (100A, 100B) can be gradually decreased from one outmost side of the multilayer reflective sheet 10 to the middle of the multilayer reflective sheet 10, and the thicknesses (h1˜h100) of another 100 polymer films (100A, 100B) can be gradually decreased from another outmost side of the multilayer reflective sheet 10 to the middle of the multilayer reflective sheet 10, thus the thicknesses (H1˜H100) and the thicknesses (h1˜h100) can be shown as a symmetrical thickness structure. In other words, the thicknesses of the 200 polymer films (100A, 100B) can be shown as a gradient variation.

In addition, referring to FIG. 1C, the thicknesses of the 200 polymer films (100A, 100B) can be shown as a U-shaped curve alteration (such as the solid line in FIG. 1C), but the thicknesses of the conventional polymer films can be shown as an inclined line alteration (such as the dotted line in FIG. 1C). Of course, the thicknesses of the 200 polymer films (100A, 100B) also can be shown as an inverted U-shaped curve alteration in order to balance the fluid pressure and the fluid velocity in the flow channel of the mold. However, the thicknesses H1 and h1 can be the same or different, and the materials for manufacturing the thicknesses H1 and h1 can be the same or different. In addition, the thicknesses H100 and h100 also can be the same or different, and the materials for manufacturing the thicknesses H100 and h100 also can be the same or different. Referring to FIG. 1M, the semicircle feedblock 40 includes a plurality of flow channels (41˜48), where the flow channels (41, 42) are symmetrical to the flow channels (47, 48), and the flow channels (43, 44) are symmetrical to the flow channels (45, 46). In addition, the widths of the flow channels are gradually decreased from the flow channel 41 to the flow channel 44, and the flow channel 41 and the flow channel 42 are adjacent to each other and made by two different materials. After the fluid passes through the flow channels (41˜48) and be converged toward the general flow channel 49, the fluid can be outputted from the general flow channel 49. Furthermore, the instant disclosure can use a multiplier to connect two feedblocks 40 in order to increase the number of the polymer films such as the 200 polymer films (200 layers of the multilayer reflective sheet 10) as shown in FIG. 1A and FIG. 1C.

Referring to FIG. 1D and FIG. 1E, where FIG. 1D shows a curve schematic diagram of different wavelengths corresponding to different reflectivity when using 50 layers of the multilayer reflective sheet having a thickness gradient variation according to the instant disclosure, and FIG. 1E shows a curve schematic diagram of different wavelengths corresponding to different reflectivity when using 50 layers of the multilayer reflective sheet having a thickness increasing variation according to the prior art. Moreover, the number of the layers of the multilayer reflective sheet can be increased by using a multiplier. Referring to FIG. 1F and FIG. 1G, where FIG. 1F shows a curve schematic diagram of different wavelengths corresponding to different reflectivity when using 200 layers of the multilayer reflective sheet having a thickness gradient variation according to the instant disclosure, and FIG. 1G shows a curve schematic diagram of different wavelengths corresponding to different reflectivity when using 200 layers of the multilayer reflective sheet having a thickness increasing variation according to the prior art. Furthermore, the number of the layers of the multilayer reflective sheet can be increased again by using another multiplier. Referring to FIG. 1H and FIG. 1I, where FIG. 1H shows a curve schematic diagram of different wavelengths corresponding to different reflectivity when using 500 layers of the multilayer reflective sheet having a thickness gradient variation according to the instant disclosure, and FIG. 1I shows a curve schematic diagram of different wavelengths corresponding to different reflectivity when using 500 layers of the multilayer reflective sheet having a thickness increasing variation according to the prior art. Hence, when the number of the layers of the multilayer reflective sheet is increased, the curve distribution of the instant disclosure (as shown in FIG. 1H) is very similar to the curve distribution of the prior art (as shown in FIG. 1I).

Therefore, because the thicknesses of the polymer films (100A, 100B) are gradually decreased from the two outmost sides of the multilayer reflective sheet 10 to the middle of the multilayer reflective sheet 10, the thicknesses of the two polymer films (100A, 100B) on the two outmost sides are maximum in order to prevent the multilayer reflective sheet 10 from being damaged by the shearing force during the co-extrusion process. Moreover, the multilayer reflective sheet 10 has a symmetrical thickness structure, the fluid velocity and the fluid pressure in the flow channel can be balanced during the co-extrusion process.

Furthermore, according to different operating needs, the plurality of polymer films (100A, 100B) can be manufactured with thicker protection layer at its top or bottom surface, so as to protect the internal layers of the polymer films (100A, 100B). At least one of the polymer films (100A, 100B) is a ultra-violet reflector for reflecting ultra-violet lights, and can furthermore include a layer of infrared reflector for reflecting infrared lights. The ultra-violet reflector or infrared reflector can be composed of single-layer optical film or multi-layer optical films; which can be manufactured with multi-layer polymer films, and there can also be additions of metal oxide particles or ultra-violet absorbent; and can be placed via lamination on any surface of the polymer films (100A, 100B) through coating, extrusion or ultra-violet paste curing. Other functional layers (such as a scratching-resistant function, an antistatic function, a support function, a diffusivity increasing function, a tear resistance function, an impact resistance function, a UV light resistance function, an infrared light resistance function etc.) can be added for the polymer films (100A, 100B), such as locating a structure layer for increasing the strength and resilience, a protection layer for increasing resistance to scratch, a Nano-layer with self-cleansing effect, or locating a micro structure layer with convergence, diffraction, or diffusion capability on any surface of the polymer films (100A, 100B). The optical microstructure layer with specific optical effect can be prism shaped, pyramid shaped, hemisphere shaped, aspheric shaped, Frensel lens shaped, lenticular, or grating structured. Furthermore, the multilayer reflective sheet 10 can be formed through single-axial or bi-axial stretching, so that the average transmittance rate of the multilayer reflective sheet for light spectrum 380˜780 nm is selectively between 30% and 90%, thereby effectively controls the intensity of light. Also, when the multilayer reflective sheet 10 is formed through bi-axial stretching, then according to differences in usage needs, the multilayer reflective sheet 10 can selectively be polarized or non-polarized.

For example, the structure of the multilayer reflective sheet 10 is formed through many layers of material stacked in sequence of refraction rate, such as shown in FIG. 1A of the polymer films (100A, 100B); in actuality the number of layers formed by all the polymer films (100A, 100B) so as to make the multilayer reflective sheet 10 can be ranged from the tens to hundreds. FIG. 1A is merely a schematic representation of the multi-layer structure, and does not show structure layers in the hundreds, and these tens to hundreds layers of polymer films (100A, 100B) are composed of at least two types of material inter-changing in sequence; wherein the material of one of the layer conforms to the condition of NX≠NY≠NZ, and the optical thickness (refraction rate times physical thickness) of each layer of the optical films results in phase difference. Specific phase difference is a necessary condition for generating optical interference. Through the overall thickness of the multilayer reflective sheet 10, the material, and the extent of stretching during the manufacturing process, the optical characteristic can be varied, and so adjustment can be designed according to specific needs. The characteristic of the multilayer reflective sheet 10 can be adjusted according to needs, such that via forming through single-axial or bi-axial stretching, the average transmittance rate of the multilayer reflective sheet 10 for light spectrum 380˜780 nm can be selectively between 30% and 90%.

Furthermore, the multilayer reflective sheet 10 can utilize single-axial or bi-axial stretching formation, so as to effectively adjust P and S polarization pattern ratio of the linearly polarized light; or utilize just the bi-axial stretching formation to generate lights that have no polarization pattern. Furthermore a surface structure can be located on any surface of the polymer films (100A, 100B) that forms the internal part of the multilayer reflective sheet 10. The surface structure not only provides physical structure characteristics of additional functionality such as anti-sticking and anti-scratching, but may also include a photo-catalyst layer or a self-cleansing layer that provides corresponding functionalities, such that when light beams enter the photo-catalyst layer then harmful environmental substances can be broken down. Besides specialized functionality, another function provided by locating a surface structure is to provide optical utility, such as providing structures that is prism shaped, pyramid shaped, hemisphere shaped, aspheric shaped, Fresnel lens shaped, or grating structured, or a combination thereof Simply stated, by locating a surface structure on the surface of polymer films (100A, 100B), the optical effects of convergence, blending, diffraction, and scattering can be generated.

During manufacturing process, especially while the multilayer reflective sheet 10 is forming, the molecular chain and molecular orientation of the polymer internal structure can be varied through a stretching machine in a single-axial or bi-axial formation, so that its physical characteristic changes, and the parameter affecting the stretch formation includes stretching temperature, speed, scaling factor, contraction, formation path, and heat setting temperature and time.

If single-axial or bi-axial stretching formation is utilized, generally the scaling ratio of single-axial stretching is from 1.5 to 6 times, and possibly greater, which is dependent upon needs and film material. Therein the film material of the polymer films (100A, 100B) includes polyethylene terephthalate (PET), polycarbonate (PC), tri-acetyl cellulose (TAC), polymethylmethacrylate (PMMA) particle, methylmethacrylate styrene (MS), polypropylene (PP), polystyrene (PS), polymethylmethacrylate (PMMA), cyclic olefin copolymer (COC), polyethylene naphthalate (PEN), ethylene-tetrafluoroethylene (ETFE), polylactide (PLA), or a mix or polymerization of these materials thereof Those optical elements formed via single-axial stretching formation can have specific directional polarization effect, thereby be used to adjust polarized wavelength range for light.

If bi-axial stretching formation is utilized, the scaling factor for each axial can be different, and the stretching formation can be according to sequence or both axial simultaneously, so that besides able to adjust for wavelength range, P and S polarization pattern ratio of light passing through multilayer reflective sheet 10 can also be managed, such that adjustment can be made to near non-polarized condition.

Referring to FIG. 1J, the first embodiment of the instant disclosure provides a method of manufacturing a reflective optical film, comprising: forming a multilayer reflective sheet 10 composed of a plurality of polymer films (100A, 100B) stacked on top of one another by a co-extrusion process, wherein each polymer film (100A or 100B) has a thickness, every two adjacent polymer films (100A, 100B) are two different materials, the thicknesses of the polymer films (100A, 100B) are gradually decreased from two outmost sides of the multilayer reflective sheet 10 to a middle of the multilayer reflective sheet 10, at least one of the polymer films (100A, 100B) is a birefringence material layer that can conform to the condition of NX≠NY≠NZ, wherein NX is the index of refraction of light at X direction of the multilayer reflective sheet 10, NY is the index of refraction of light at Y direction of the multilayer reflective sheet 10, and NZ is the index of refraction of light at Z direction of the multilayer reflective sheet 10 (S100); extending the multilayer reflective sheet 10 (S102); and then respectively placing a first functional layer 11A and a second functional layer 11B on a first surface and a second surface of the multilayer reflective sheet 10 (S104).

Furthermore, FIG. 1K shows a schematic diagram of the method for manufacturing a multi-layer structure according to the instant disclosure. A multi-layer extrusion process is particularly used to form a multi-layer substrate. As shown in the diagram, the materials are used to form the multiple layers via different feeding regions. In the preferred embodiment, the materials are separately fed via the primary feeding region D1 and the secondary feeding region D2, and then a screw rod D3 and a heater D4 disposed on the feeding region are used to blend the materials. The materials have high selectivity. The material in each layer can be different. In a specific layer, the transparent diffusing beads are doped. Further, the materials are simultaneously under the blending-refine process on the feeding machine. Through the extrusion process at the mold head D5, the substrate with a certain thickness is obtained. After the modulation by the rolls D6, the thickness can be adjusted. After that, the surface structure is formed on one surface or both above and below surfaces. At last step of cooling through the cooling plate D7, the materials are solidified. The examination machines D8 can be used to examine the final product such as the reflective optical film.

According to one of the embodiments of the instant disclosure, the multilayer reflective sheet 10 is formed by a plurality of composite materials after repeatedly stacking in the co-extrusion procedure. The variant refractive indexes and thicknesses of the multilayer reflective sheet 10 formed by multiple types of high-polymer meet the condition of optical interference that cause the light polarized and reflected. Since the interference condition is seriously defined, the coating technology used for the general optical lens often require multiple layers with high and low refractive indexes, such as dozen or hundred layers. In the instant disclosure, the multilayer reflective sheet 10 can increase the reflectivity of polarized light by producing multiple times of interfered reflection through the multiple layers with high and low refractive indexes. That will be like the mentioned interference made by plural films. The multilayer reflective sheet 10 will have better reflectivity to a certain wavelength when the multilayer reflective sheet 10 has more layers stacked and better evenness control for higher variations of the refractive indexes. For example, the current embodiment repeatedly stacks the PET and PEN materials to form an (AB)ⁿ structure in the co-extrusion process. In which, n is an integer which is ranged within 10 to 500 based on the design, and the preferred value is within 120 through 180. When the temperature in the stretch procedure is controlled just as the anisotropy of the birefringence of the material happens, that is to make the refractive indexes of anisotropic and isotropic films change, and meanwhile the thickness with one-quarter wavelength is also employed, it is to accomplish the interference of multi-layer.

Furthermore, referring to FIG. 1B and FIG. 1L, the first embodiment of the instant disclosure further provides an image display device M, comprising: a reflective light-polarizing unit 1 and an image display unit 2. The image display unit 2 includes at least one image display screen 20, wherein the reflective light-polarizing unit 1 is disposed on the top side of the at least one image display screen 20.

### Second Embodiment

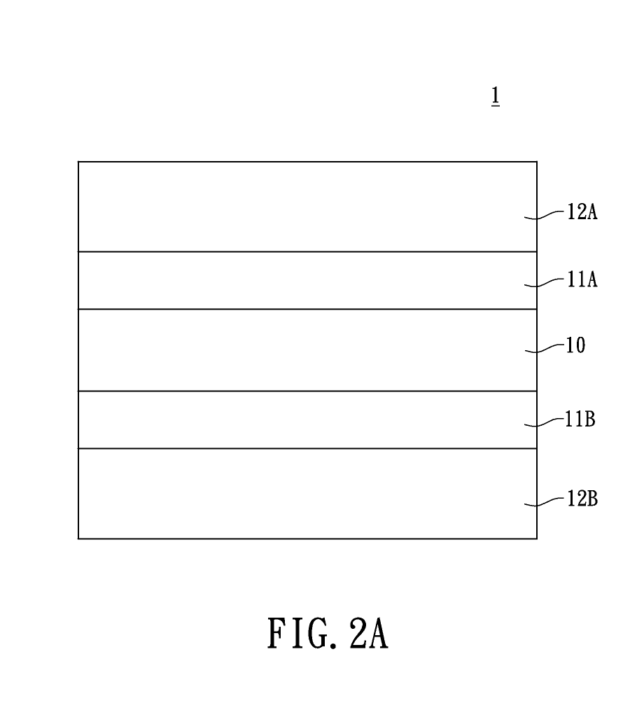

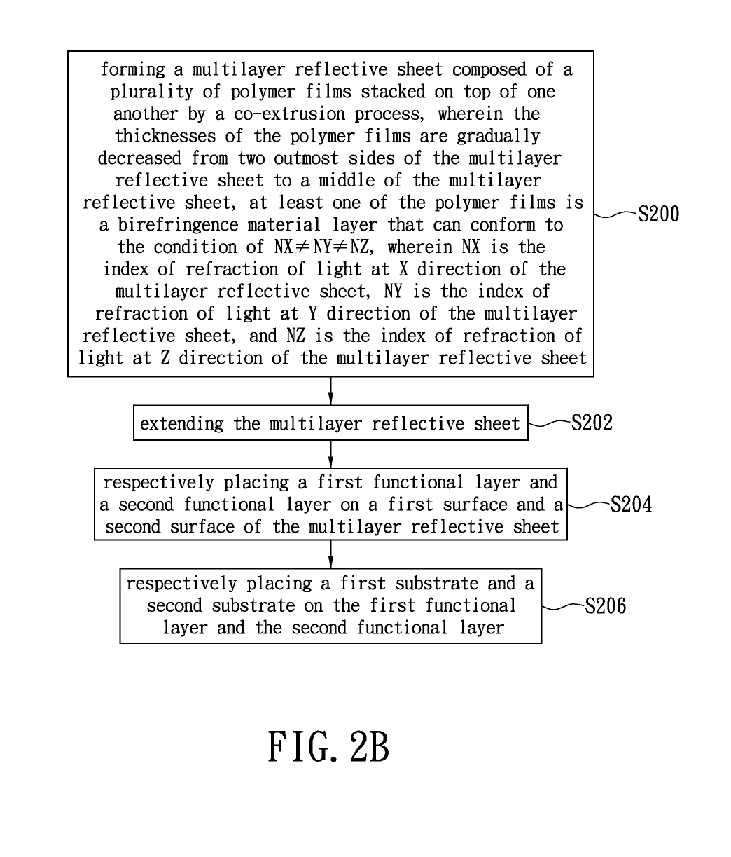

Referring to FIG. 2A, the second embodiment of the instant disclosure provides a reflective optical film comprising a reflective light-polarizing unit 1. Comparing FIG. 2A with FIG. 1B, the difference between the second embodiment and the first embodiment is as follows: in the second embodiment, the reflective light-polarizing unit 1 further includes a first substrate 12A and a second substrate 12B respectively disposed on the first functional layer 11A and the second functional layer 11B. For example, the first substrate 12A and the second substrate 12B are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA), where the first functional layer 11A, the second functional layer 11B, the first substrate 12A or the second substrate 12B also can be manufactured as a multilayer structure.

Referring to FIG. 2B, the second embodiment provides a method of manufacturing a reflective optical film, comprising: forming a multilayer reflective sheet 10 composed of a plurality of polymer films (100A, 100B) stacked on top of one another by a co-extrusion process, wherein each polymer film (100A or 100B) has a thickness, every two adjacent polymer films (100A, 100B) are two different materials, the thicknesses of the polymer films (100A, 100B) are gradually decreased from two outmost sides of the multilayer reflective sheet 10 to a middle of the multilayer reflective sheet 10, at least one of the polymer films (100A, 100B) is a birefringence material layer that can conform to the condition of NX≠NY≠NZ, wherein NX is the index of refraction of light at X direction of the multilayer reflective sheet 10, NY is the index of refraction of light at Y direction of the multilayer reflective sheet 10, and NZ is the index of refraction of light at Z direction of the multilayer reflective sheet 10 (S200); extending the multilayer reflective sheet 10 (S202); respectively placing a first functional layer 11A and a second functional layer 11B on a first surface and a second surface of the multilayer reflective sheet 10 (S204); and then respectively placing a first substrate 12A and a second substrate 12B on the first functional layer 11A and the second functional layer 11B in order to form a reflective light-polarizing unit 1 (S206).

### Third Embodiment

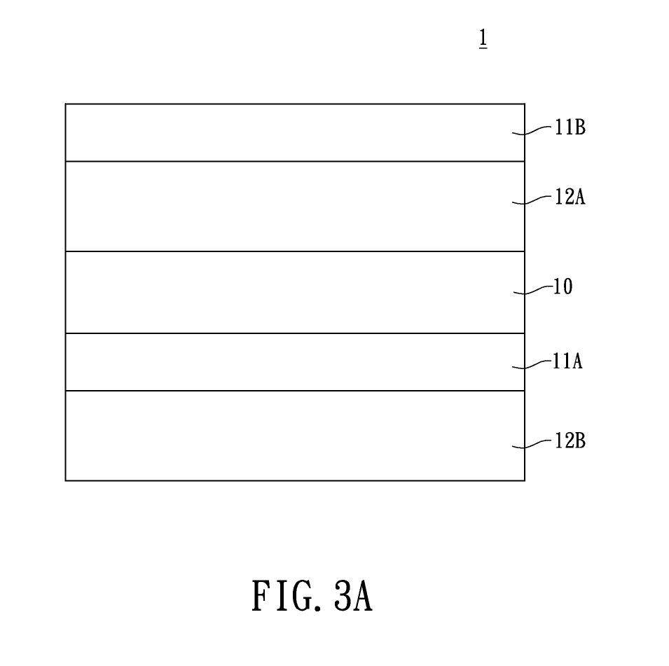

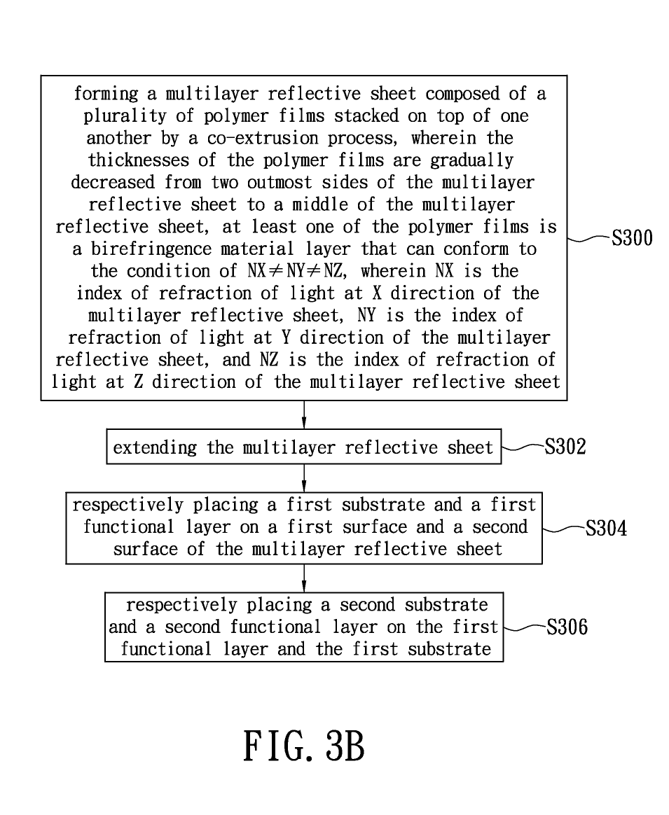

Referring to FIG. 3A, the third embodiment of the instant disclosure provides a reflective optical film comprising a reflective light-polarizing unit 1. Comparing FIG. 3A with FIG. 1B, the difference between the third embodiment and the first embodiment is as follows: in the third embodiment, the first substrate 12A and the first functional layer 11A are respectively disposed on a first surface and a second surface of the multilayer reflective sheet 10, and the second substrate 12B and the second functional layer 11B are respectively disposed on the first functional layer 11A and the first substrate 12A.

Referring to FIG. 3B, the third embodiment provides a method of manufacturing a reflective optical film, comprising: forming a multilayer reflective sheet 10 composed of a plurality of polymer films (100A, 100B) stacked on top of one another by a co-extrusion process, wherein each polymer film (100A or 100B) has a thickness, every two adjacent polymer films (100A, 100B) are two different materials, the thicknesses of the polymer films (100A, 100B) are gradually decreased from two outmost sides of the multilayer reflective sheet 10 to a middle of the multilayer reflective sheet 10, at least one of the polymer films (100A, 100B) is a birefringence material layer that can conform to the condition of NX≠NY≠NZ, wherein NX is the index of refraction of light at X direction of the multilayer reflective sheet 10, NY is the index of refraction of light at Y direction of the multilayer reflective sheet 10, and NZ is the index of refraction of light at Z direction of the multilayer reflective sheet 10 (S300); extending the multilayer reflective sheet 10 (S302); respectively placing a first substrate 12A and a first functional layer 11A on a first surface and a second surface of the multilayer reflective sheet 10 (S304); and then respectively placing a second substrate 12B and a second functional layer 11B on the first functional layer 11A and the first substrate 12A in order to form a reflective light-polarizing unit 1 (S306).

### Fourth Embodiment

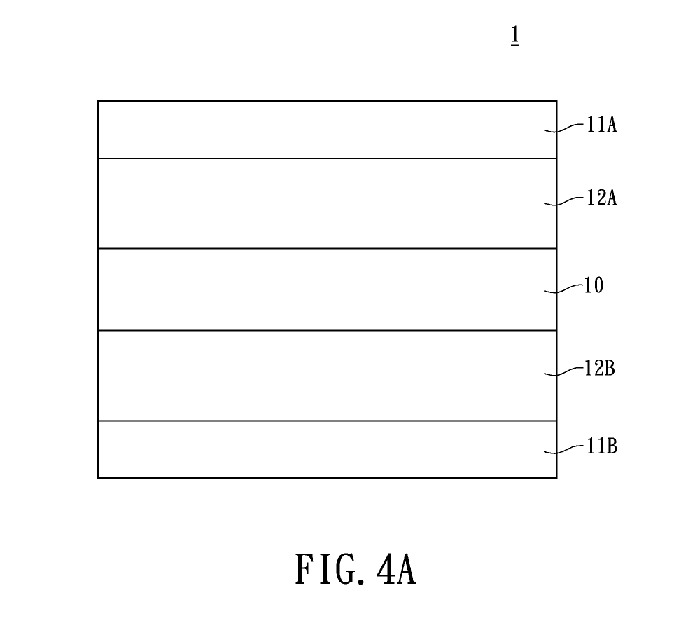

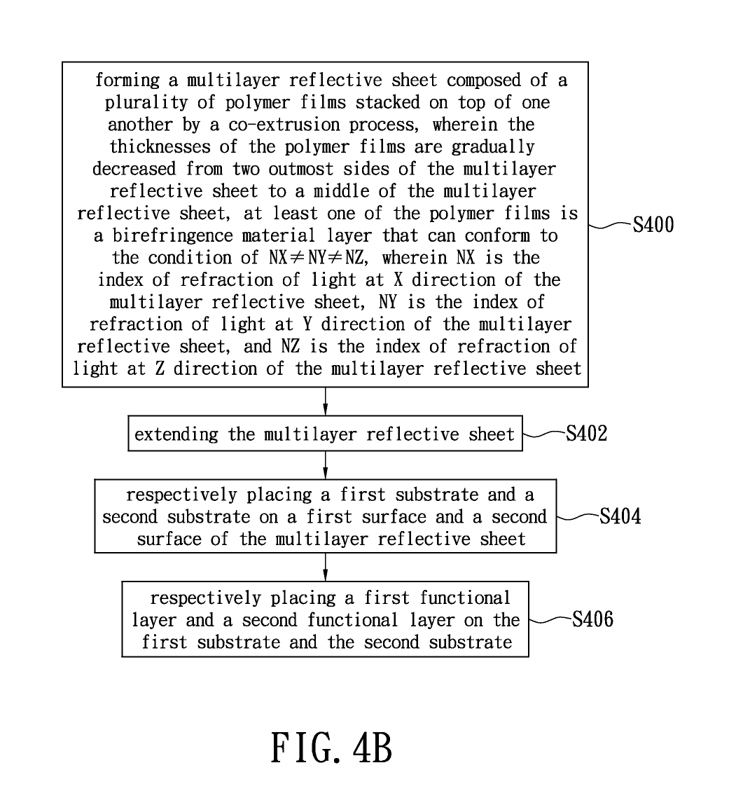

Referring to FIG. 4A, the fourth embodiment of the instant disclosure provides a reflective optical film comprising a reflective light-polarizing unit 1. Comparing FIG. 4A with FIG. 1B, the difference between the fourth embodiment and the first embodiment is as follows: in the fourth embodiment, the first substrate 12A and the second substrate 12B are respectively disposed on a first surface and a second surface of the multilayer reflective sheet 10, and the first functional layer 11A and the second functional layer 11B are respectively disposed on the first substrate 12A and the second substrate 12B.

Referring to FIG. 4B, the fourth embodiment provides a method of manufacturing a reflective optical film, comprising: forming a multilayer reflective sheet 10 composed of a plurality of polymer films (100A, 100B) stacked on top of one another by a co-extrusion process, wherein each polymer film (100A or 100B) has a thickness, every two adjacent polymer films (100A, 100B) are two different materials, the thicknesses of the polymer films (100A, 100B) are gradually decreased from two outmost sides of the multilayer reflective sheet 10 to a middle of the multilayer reflective sheet 10, at least one of the polymer films (100A, 100B) is a birefringence material layer that can conform to the condition of NX≠NY≠NZ, wherein NX is the index of refraction of light at X direction of the multilayer reflective sheet 10, NY is the index of refraction of light at Y direction of the multilayer reflective sheet 10, and NZ is the index of refraction of light at Z direction of the multilayer reflective sheet 10 (S400); extending the multilayer reflective sheet 10 (S402); respectively placing a first substrate 12A and a second substrate 12B on a first surface and a second surface of the multilayer reflective sheet 10 (S404); and then respectively placing a first functional layer 11A and a second functional layer 11B on the first substrate 12A and the second substrate 12B in order to form a reflective light-polarizing unit 1 (S406).

### Fifth Embodiment

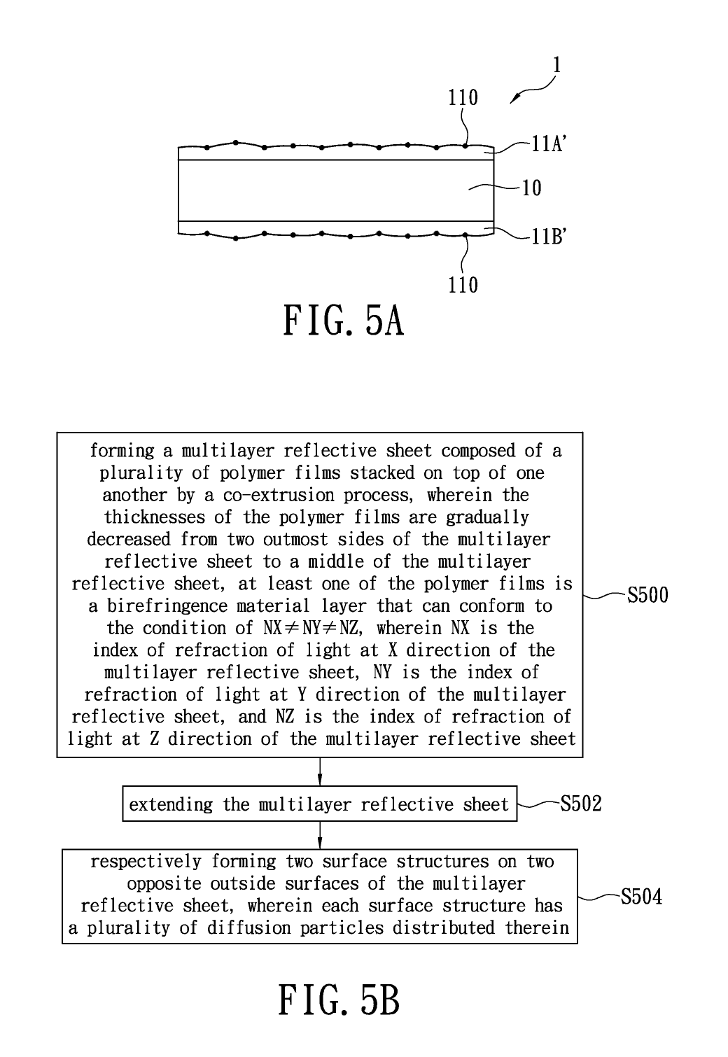

Referring to FIG. 5A, the fifth embodiment of the instant disclosure provides a reflective optical film comprising a reflective light-polarizing unit 1. Comparing FIG. 5A with FIG. 1B, the difference between the fifth embodiment and the first embodiment is as follows: in the fifth embodiment, the multilayer reflective sheet 10 includes two surface structures (11A′, 11B′) respectively formed on two opposite outside surfaces thereof, and each surface structure (11A′, 11B′) has a plurality of diffusion particles 110 distributed therein.

Referring to FIG. 5B, the fifth embodiment provides a method of manufacturing a reflective optical film, comprising: forming a multilayer reflective sheet 10 composed of a plurality of polymer films (100A, 100B) stacked on top of one another by a co-extrusion process, wherein each polymer film (100A or 100B) has a thickness, every two adjacent polymer films (100A, 100B) are two different materials, the thicknesses of the polymer films (100A, 100B) are gradually decreased from two outmost sides of the multilayer reflective sheet 10 to a middle of the multilayer reflective sheet 10, at least one of the polymer films (100A, 100B) is a birefringence material layer that can conform to the condition of NX≠NY≠NZ, wherein NX is the index of refraction of light at X direction of the multilayer reflective sheet 10, NY is the index of refraction of light at Y direction of the multilayer reflective sheet 10, and NZ is the index of refraction of light at Z direction of the multilayer reflective sheet 10 (S500); extending the multilayer reflective sheet 10 (S502); respectively forming two surface structures (11A′, 11B′) on two opposite outside surfaces of the multilayer reflective sheet 10, wherein each surface structure (11A′, 11B′) has a plurality of diffusion particles 110 distributed therein (S504).

### Sixth Embodiment

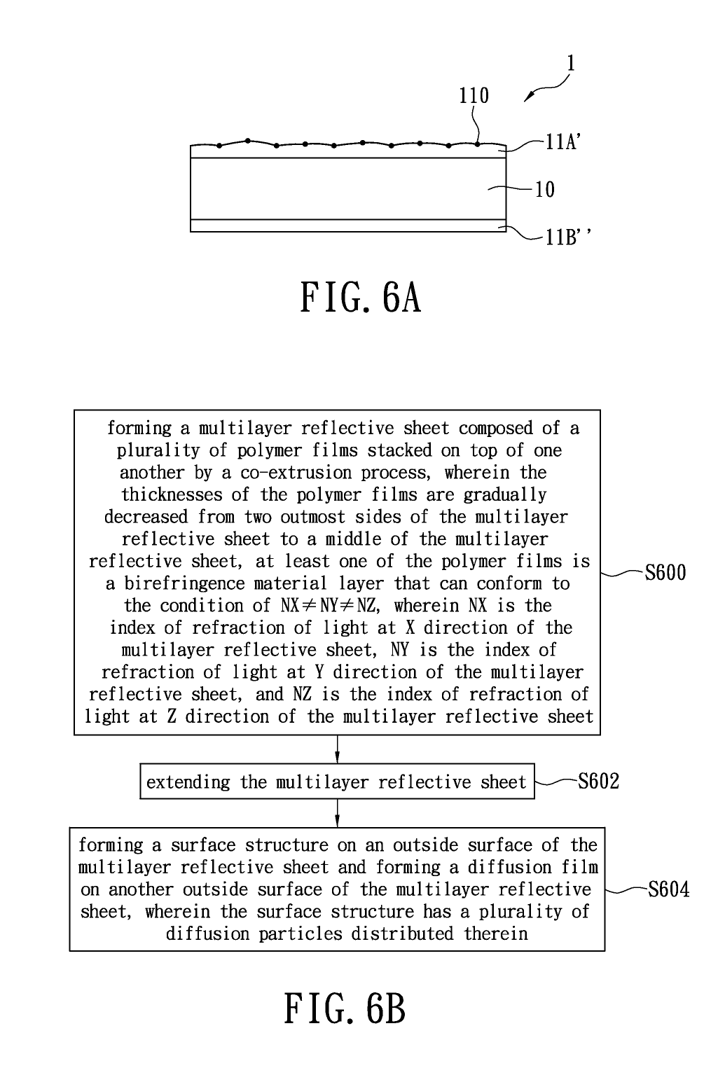

Referring to FIG. 6A, the sixth embodiment of the instant disclosure provides a reflective optical film comprising a reflective light-polarizing unit 1. Comparing FIG. 6A with FIG. 1B, the difference between the sixth embodiment and the first embodiment is as follows: in the sixth embodiment, the multilayer reflective sheet 10 includes a surface structure 11A′ formed on an outside surface thereof, the multilayer reflective sheet 10 includes a diffusion film 11B″ formed on another outside surfaces thereof, and the surface structure 11A′ has a plurality of diffusion particles 110 distributed therein.

Referring to FIG. 6B, the sixth embodiment provides a method of manufacturing a reflective optical film, comprising: forming a multilayer reflective sheet 10 composed of a plurality of polymer films (100A, 100B) stacked on top of one another by a co-extrusion process, wherein each polymer film (100A or 100B) has a thickness, every two adjacent polymer films (100A, 100B) are two different materials, the thicknesses of the polymer films (100A, 100B) are gradually decreased from two outmost sides of the multilayer reflective sheet 10 to a middle of the multilayer reflective sheet 10, at least one of the polymer films (100A, 100B) is a birefringence material layer that can conform to the condition of NX‥NY≠NZ, wherein NX is the index of refraction of light at X direction of the multilayer reflective sheet 10, NY is the index of refraction of light at Y direction of the multilayer reflective sheet 10, and NZ is the index of refraction of light at Z direction of the multilayer reflective sheet 10 (S600); extending the multilayer reflective sheet 10 (S602); forming a surface structure 11A′ on an outside surface of the multilayer reflective sheet 10 and forming a diffusion film 11B″ on another outside surface of the multilayer reflective sheet 10, wherein the surface structure 11A′ has a plurality of diffusion particles 110 distributed therein (S604).

### Seventh Embodiment

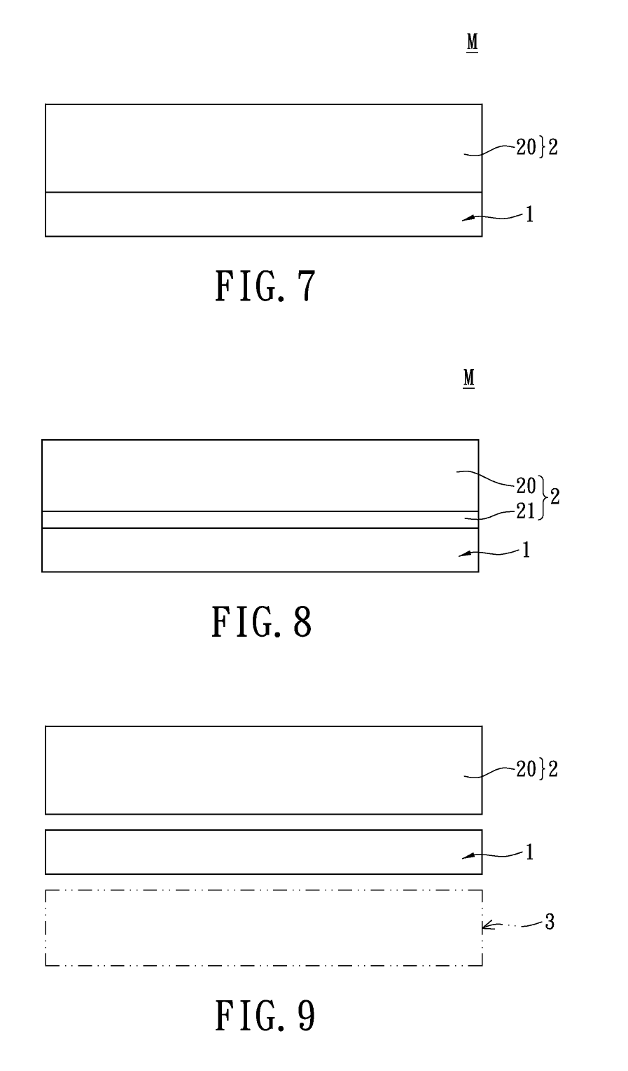

Referring to FIG. 7, the seventh embodiment of the instant disclosure provides an image display device M comprising a reflective light-polarizing unit 1 and an image display unit 2. Comparing FIG. 7 with FIG. 1L, the difference between the seventh embodiment and the first embodiment is as follows: in the seventh embodiment, the reflective light-polarizing unit 1 is disposed on the bottom side of the at least one image display screen 20.

### Eighth Embodiment

Referring to FIG. 8, the eighth embodiment of the instant disclosure provides an image display device M comprising a reflective light-polarizing unit 1 and an image display unit 2. Comparing FIG. 8 with FIG. 7, the difference between the eighth embodiment and the seventh embodiment is as follows: in the eighth embodiment, the image display unit 2 includes an image display screen 20 and an absorption polarization plate 21 disposed on the bottom side of the image display screen 20 in advance, thus the reflective light-polarizing unit 1 can be disposed on the bottom side of the absorption polarization plate 21. In other words, the reflective light-polarizing unit 1 can be disposed on the bottom side of the image display unit 2.

### Ninth Embodiment

Referring to FIG. 9, the ninth embodiment of the instant disclosure provides an image display device M comprising a reflective light-polarizing unit 1 and an image display unit 2. Comparing FIG. 9 with FIG. 1L, the difference between the ninth embodiment and the first embodiment is as follows: in the ninth embodiment, the reflective light-polarizing unit 1 is movably disposed between the image display screen 20 and a backlight module 3. In other words, the reflective light-polarizing unit 1 can be selectively disposed (1) on the top side of the image display unit 2 (as shown in FIG. 1L), (2) on the bottom side of the image display unit 2 (as shown in FIG. 7 and FIG. 8), or (3) between the image display screen 20 and the backlight module 3 (as shown in FIG. 9).

In conclusion, because the thicknesses of the polymer films (100A, 100B) are gradually decreased from the two outmost sides of the multilayer reflective sheet 10 to the middle of the multilayer reflective sheet 10, the thicknesses of the two polymer films (100A, 100B) on the two outmost sides are maximum in order to prevent the multilayer reflective sheet 10 from being damaged by the shearing force during the co-extrusion process. Moreover, the multilayer reflective sheet 10 has a symmetrical thickness structure, the fluid velocity and the fluid pressure in the flow channel can be balanced during the co-extrusion process.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A reflective optical film, comprising: a reflective light-polarizing unit including a multilayer reflective sheet composed of a plurality of polymer films stacked on top of one another, wherein each polymer film has a thickness, every two adjacent polymer films are two different materials, the thicknesses of the polymer films are gradually decreased from two outmost sides of the multilayer reflective sheet to a middle of the multilayer reflective sheet, at least one of the polymer films is a birefringence material layer that conforms to the condition of NX≠NY≠NZ, wherein NX is the index of refraction of light at X direction of the multilayer reflective sheet, NY is the index of refraction of light at Y direction of the multilayer reflective sheet, and NZ is the index of refraction of light at Z direction of the multilayer reflective sheet.

2. The reflective optical film of claim 1, wherein the reflective light-polarizing unit includes a first functional layer and a second functional layer respectively disposed on a first surface and a second surface of the at least one multilayer reflective sheet.

3. The reflective optical film of claim 2, wherein the reflective light-polarizing unit includes a first substrate and a second substrate respectively disposed on the first functional layer and the second functional layer.

4. The reflective optical film of claim 1, wherein the reflective light-polarizing unit includes a first substrate, a second substrate, a first functional layer, and a second functional layer, the first substrate and the first functional layer are respectively disposed on a first surface and a second surface of the at least one multilayer reflective sheet, and the second substrate and the second functional layer are respectively disposed on the first functional layer and the first substrate.

5. The reflective optical film of claim 1, wherein the reflective light-polarizing unit includes a first substrate, a second substrate, a first functional layer, and a second functional layer, the first substrate and the second substrate are respectively disposed on a first surface and a second surface of the at least one multilayer reflective sheet, and the first functional layer and the second functional layer are respectively disposed on the first substrate and the second substrate.

6. The reflective optical film of claim 1, wherein the multilayer reflective sheet includes two surface structures respectively formed on two opposite outside surfaces thereof, and each surface structure has a plurality of diffusion particles distributed therein.

7. The reflective optical film of claim 1, wherein the multilayer reflective sheet includes a surface structure formed on an outside surface thereof, and the surface structure has a plurality of diffusion particles distributed therein.

8. An image display device, comprising:
a reflective light-polarizing unit including a multilayer reflective sheet composed of a plurality of polymer films stacked on top of one another, wherein each polymer film has a thickness, every two adjacent polymer films are two different materials, the thicknesses of the polymer films are gradually decreased from two outmost sides of the multilayer reflective sheet to a middle of the multilayer reflective sheet, at least one of the polymer films is a birefringence material layer that conforms to the condition of NX≠NY≠NZ, wherein NX is the index of refraction of light at X direction of the multilayer reflective sheet, NY is the index of refraction of light at Y direction of the multilayer reflective sheet, and NZ is the index of refraction of light at Z direction of the multilayer reflective sheet; and
an image display unit including at least one image display screen, wherein the reflective light-polarizing unit is disposed on one of the top side and the bottom side of the at least one image display screen or between the at least one image display screen and a backlight module.

9. The image display device of claim 8, wherein the reflective light-polarizing unit includes a first functional layer and a second functional layer respectively disposed on a first surface and a second surface of the at least one multilayer reflective sheet.

10. The image display device of claim 9, wherein the reflective light-polarizing unit includes a first substrate and a second substrate respectively disposed on the first functional layer and the second functional layer.

11. The image display device of claim 8, wherein the reflective light-polarizing unit includes a first substrate, a second substrate, a first functional layer, and a second functional layer, the first substrate and the first functional layer are respectively disposed on a first surface and a second surface of the at least one multilayer reflective sheet, and the second substrate and the second functional layer are respectively disposed on the first functional layer and the first substrate.

12. The image display device of claim 8, wherein the reflective light-polarizing unit includes a first substrate, a second substrate, a first functional layer, and a second functional layer, the first substrate and the second substrate are respectively disposed on a first surface and a second surface of the at least one multilayer reflective sheet, and the first functional layer and the second functional layer are respectively disposed on the first substrate and the second substrate.

13. The image display device of claim 8, wherein the multilayer reflective sheet includes two surface structures respectively formed on two opposite outside surfaces thereof, and each surface structure has a plurality of diffusion particles distributed therein.

14. The image display device of claim 8, wherein the multilayer reflective sheet includes a surface structure formed on an outside surface thereof, and the surface structure has a plurality of diffusion particles distributed therein.

15. A method of manufacturing a reflective optical film, comprising:
forming a multilayer reflective sheet composed of a plurality of polymer films stacked on top of one another by a co-extrusion process, wherein each polymer film has a thickness, every two adjacent polymer films are two different materials, the thicknesses of the polymer films are gradually decreased from two outmost sides of the multilayer reflective sheet to a middle of the multilayer reflective sheet, at least one of the polymer films is a birefringence material layer that conforms to the condition of NX #NY#NZ, wherein NX is the index of refraction of light at X direction of the multilayer reflective sheet, NY is the index of refraction of light at Y direction of the multilayer reflective sheet, and NZ is the index of refraction of light at Z direction of the multilayer reflective sheet; and
extending the multilayer reflective sheet.

16. The method of claim 15, wherein after the step of extending the multilayer reflective sheet, the method further comprises: respectively placing a first functional layer and a second functional layer on a first surface and a second surface of the at least one multilayer reflective sheet, and then respectively placing a first substrate and a second substrate on the first functional layer and the second functional layer.

17. The method of claim 15, wherein after the step of extending the multilayer reflective sheet, the method further comprises: respectively placing a first substrate and a first functional layer on a first surface and a second surface of the at least one multilayer reflective sheet, and then respectively placing a second substrate and a second functional layer on the first functional layer and the first substrate, in order to form a reflective light-polarizing unit.

18. The method of claim 15, wherein after the step of extending the multilayer reflective sheet, the method further comprises: respectively placing a first substrate and a second substrate on a first surface and a second surface of the at least one multilayer reflective sheet, and then respectively placing a first functional layer and a second functional layer on the first substrate and the second substrate, in order to form a reflective light-polarizing unit.

19. The method of claim 15, further comprising: respectively forming two surface structures on two opposite outside surfaces of the multilayer reflective sheet, wherein each surface structure has a plurality of diffusion particles distributed therein.

20. The method of claim 15, further comprising: forming a surface structure on an outside surface of the multilayer reflective sheet, wherein the surface structure has a plurality of diffusion particles distributed therein.
